(19) United States
(12) Patent Application Publication
(10) Pub. No.: US 2011/0243376 A1
(43) Pub. Date: Oct. 6, 2011

(54) METHOD AND A DEVICE FOR DETECTING OBJECTS IN AN IMAGE

(75) Inventors: Stefan Lüke, Olpe (DE); Edgar Semann, Konigsheim (DE); Bernt Schiele, Darmstadt (DE); Christan Wojek, Darmstadt (DE)

(73) Assignee: Continental Teves AG & oHG, Frankfurt (DE)

(21) Appl. No.: 12/672,007

(22) PCT Filed: Aug. 4, 2008
(86) PCT No.: PCT/EP2008/060228

§ 371 Date: Nov. 3, 2010

(30) Foreign Application Priority Data
Aug. 4, 2007 (DE) 10 2007 036 966.4
Oct. 23, 2007 (DE) 10 2007 050 568.1

(51) Int. Cl. G06K 9/00

(52) U.S. Cl. 382/103

(57) ABSTRACT

Detection of an object of a specified object category in an image. With the method, it is provided that: (1) at least two detectors are provided which are respectively set up for the purpose of detecting an object of the specified object category with a specified object size, wherein object sizes differ for the detectors, (2) the image is evaluated by the detectors in order to check whether an object of the specified object category is located in the image, and (3) an object of the specified object category is detected in the image when on the basis of the evaluation of the image by at least one of the detectors it is determined that an object of the specified object category is located in the image. A system suitable for implementing the method for detecting an object of a specified object category in an image is also described.

### CROSS REFERENCE TO RELATED APPLICATIONS

This application is the U.S. national phase application of PCT International Application No. PCT/EP2008/060228, filed Aug. 4, 2008, which claims priority to German Patent Application No. DE 10 2007 036 966.4, filed Aug. 4, 2007, and German Patent Application No. DE 10 2007 050 568.1 filed Oct. 23, 2007, the contents of such applications being incorporated herein by reference.

### FIELD OF THE INVENTION

The invention relates to a method for detecting an object of a specified object category in an image. Furthermore, the invention relates to a system which is suitable for implementing the method for detecting an object of a specified object category in an image.

### BACKGROUND OF THE INVENTION

A method for detecting persons in images is described in Navneet Dalal, “Finding People in Images and Videos”, dissertation, Institut National Polytechnique de Grenoble/INRIA Rhone-Alpes, July 2006, which is incorporated by reference. With the method, a detector which is based on a window of a specified size, is trained to find people in a corresponding image section. The detector window is moved respectively over the image during several scaling operations in order to find people. Then, multiple detection events are fusioned for one single person. Due to the fact that the image is evaluated in several scaling operations, people of different sizes can be found, since one person is usually found in a scaling operation in which their image is approximately the same size as the detector window.

However, it has been determined that with the method, the detection capacity for objects of different sizes varies, and is reduced in particular in relation to small objects, i.e. objects which are further away from the camera sensor which is used for recording the images. In some applications, however, the detection of smaller objects in particular is of key importance.

An example of this is the detection of oncoming motor vehicles in images which are recorded using an on-board camera of a motor vehicle. Due to a detection of similar motor vehicles and the determination of their positions and speeds, potential collisions can be pre-calculated and suitable measures can be initiated to prevent the collisions or to protect the passengers of the motor vehicle. In particular, measures to prevent collisions should here be initiated as early as possible, in order to be effective. For this purpose, it is necessary to already detect an oncoming motor vehicle when it is still far away from the on-board camera, and to evaluate its driving behaviour.

### SUMMARY OF THE INVENTION

For this reason, an object of the present invention is in particular to improve the detection capacity for smaller objects.

Accordingly, a method of the type described in the introduction is implemented in such a manner that:
at least two detectors are provided which are respectively set up to detect an object of the specified object category with a specified object size, wherein window sizes of the window-based object detectors differ,
the image is evaluated by the detectors in order to check whether an object of the specified object category is present in the image at a particular point, and
an object of the specified object category is detected at a certain point in the image when on the basis of the evaluation of the image by at least one of the detectors it is determined that an object of the specified object category is present in the image at this point.

Furthermore, a system for detecting an object of a specified object category is provided in an image. The system comprises:
at least two detectors which are respectively set up to detect an object of the specified object category, wherein the object sizes differ for the detectors, and
an evaluation device which is designed to determine a detection of an object of the specified object category within the image when on the basis of the evaluation of the image by at least one of the detectors it is determined that an object of the specified object category is present in the image.

The invention relates to the notion of providing several detectors which are respectively designed to detect objects in a specific size range. As a result, over the entire size range in which objects occur in the images to be evaluated, good detection capacities are achieved to an essentially consistent degree. Here, the invention relates to the recognition that a detector shows the best detection capacity in relation to objects which are of a size which corresponds to the size of the objects which are used for training the detector.

In particular, it was here determined that the detection capacity of a single detector for detecting objects of all sizes which occur as is known from the prior art is low for small objects as compared to medium-sized and large objects. The reason of this is probably that with a certain size of an object in an image, a certain degree of displayed details of the object follows. If a detector is trained for detecting objects, a degree of details is taken into account during the training procedure. This results in the fact that objects for which the detailing is far lower, as is particularly the case with small objects, are less well detected. The invention makes it possible in particular to use a detector which is specially set up for detecting small objects, so that the detection capacity in relation to the precision above all for small objects can be significantly increased.

Within the scope of the invention, the images are in particular digitalised images which comprise a certain number of so-called pixels. A size of an object or an image is thus within the scope of the invention in particular the horizontal and vertical expansion of the object or image within the image plane measured in the number of pixels of the image, i.e. an image has a “size” of nₓ×n_{y} pixels, wherein nₓ gives the number of pixels in the horizontal expansion and n_{y} gives the number of pixels in the vertical expansion. The horizontal expansion here corresponds to the x direction and the vertical expansion corresponds to the y direction.

In one embodiment of the method and the system, it is provided that each detector evaluates at least one section of the image which is covered by a detector window, wherein the size of the detector window of the detectors is adapted to the object size specified for the detector.

The size range to which a detector is adapted here depends in particular on the size of the detector window, in particular on the size of the objects which can be completely covered by the detector window. Thus, this embodiment has the advantage that the adaptation of the detector to an object size is conducted in particular on the basis of the selection of the size of the detector window in which an image evaluation is conducted by the detector.

A further embodiment of the method and the system provides that each detector conducts evaluations of image sections which are covered by the detector window of the detector at a plurality of positions of the detector window in the image, wherein the positions have a specified distance from each other.

As a result, it is advantageously achieved that objects can be detected at any position within the image. At a certain position, the detection is conducted when the evaluation of an image section is conducted which covers the object.

Furthermore, one embodiment of the method and the system is characterised by the fact that the image is evaluated in a plurality of scaling operations, wherein during each scaling operation of the image, each detector conducts evaluations of image sections which are covered by the detector window of the detector at a plurality of positions of the detector window in the image.

Here, the scaling operation refers within the scope of the invention to a change in the display scale of the image content, in particular a change in the number of pixels in the image. If the original image has nₓ×n_{y} pixels, the scaled image has (n_{x/s})×(n_{y/s}) pixels for example, wherein s is a scaling factor. If the image content is reduced in size by the scaling operation, this can for example be achieved by a compilation of the image information from several pixels to one pixel, which can be conducted e.g. using bilinear interpolation.

An object which has a certain size within the image is here detected by one of the detectors when the image is evaluated in a scaling operation in which the object has a size which approximately corresponds to the size of the detector window of the detector. The embodiment thus has the advantage that objects of any size can be detected within the image.

In this context, it was also determined that the detection capacity can also be improved with an evaluation of the image in several scaling operations by using several detectors which are respectively adapted to a certain size range of the objects. This is attributed to the fact—as has been mentioned above—that the size of an object within the image is entailed with a certain degree of detailing of the object, which does not change as a result of a scaling of the image. Thus, the image can be scaled in such a manner that a small object essentially completely fills the detector window of a detector which is adapted to detect larger objects, while at the same time, due to the low level of detailing of the object, this detector is possibly not capable of detecting the object.

One embodiment of the method and the system furthermore provides that at least one first detector is set up in order to take into account image information when evaluating an image section which is covered by the detector window of the first detector, which is located in the image section in a first surrounding area of an object of the specified object category.

It was determined that the detection capacity of the individual detectors can be improved by taking into account such context information. This is attributed to the fact that a detector is capable of learning that the objects to be detected generally occur within defined contexts, and the probability of the presence of an object is less when such a context is not present.

One indication of the type of object is given in particular by the subsurface on which the real object is located, which is arranged within an image below the object in such a manner that at least this context area can be taken into account. A further improvement can be achieved when the complete area surrounding the object is taken into account within the image as a context area.

For this reason, it is provided in one embodiment of the method and the system that the surrounding area comprises a part of the image section below the object and/or that the surrounding area completely surrounds the object.

It has been shown that the detection capacity can be increased by taking into account context information, in particular in relation to the detection of small objects. It is therefore advantageous in relation to the detection of small objects to take into account a larger context area than in relation to the detection of large objects.

For this reason, a further embodiment of the method and the system provides that at least one additional detector is set up in such a manner as to take into account image information when evaluating an image section which is covered by the detector window of the additional detector, which is located in the image section in a second surrounding area of an object of the specified object category, wherein the additional detector for detecting smaller objects is designed as the first detector, and whereby the share of the second surrounding area on the image section which is covered by the detector window of the additional detector is larger than the share of the first surrounding area on the image section which is covered by the detector window of the first detector.

Furthermore, one embodiment of the method and the system is characterised by the fact that the evaluation of an image section which is covered by a detector window of a detector comprises the calculation of a descriptor, wherein the descriptor is fed to a classifier which calculates whether an object of the specified object category is located in the image section.

The descriptor is advantageously a set of features of an image section which is preferably calculated in the form of a vector which is also referred to as the descriptor vector or feature vector. This vector can be fed to the classifier of the detector in order to calculate on the basis of the features whether an object of the specified object category is contained in the image section.

A further embodiment of the invention and the system here provides that the calculation of the descriptor comprises a gamma compression of the image.

As a result of such a gamma compression, in particular differences in the lighting of different image areas and between different images can be compensated. In particular, for this purpose, the gamma compression can be conducted whereby the root of the intensity of the pixels of the image is calculated, which is a measure for the brightness of the pixel or the light intensity of the pixel. With colour images, the calculation is here made for each colour channel. As an alternative to the calculation of the root of the intensities, other compression methods can naturally also be used.

Furthermore, an embodiment of the method and the system provides that the calculation of the descriptor comprises the calculation of intensity gradients within the image and the creation of a histogram for the intensity gradients in accordance with the orientation of the intensity gradients.

Histograms of this type are particularly suitable for quantifying features of the image which can be used for object detection, since they in particular display the edges within the image and thus the outlines and structure of objects which are contained in the images.

With a further embodiment of the method and the system, it is provided that the image section is subdivided into several cells, which each comprise several pixels of the image section, wherein for each cell, a histogram is created into which the intensity gradients which are calculated in relation to the pixels of the cell are accommodated, and that several cells are respectively compiled into a block, wherein one cell is assigned to several blocks, and that the histograms are compiled and standardised in blocks, wherein the descriptor results from a combination of the descriptors which are compiled and standardised in blocks.

As a result, the so-called HOG descriptors are calculated (HOG: Histogram Oriented Gradients), which have been shown to be advantageous for object detection. Equally, however, other descriptors can be used within the scope of the invention.

In particular, different types of descriptors can be advantageous here with regard to the detection of objects of different sizes.

For this reason, one embodiment of the method and the system provides that for different detectors, different types of descriptors are used.

Furthermore, it is provided in embodiments of the method and the system that the classifier is a Support Vector Machine. Other classifiers such as the AdaBoost method are also possible.

These classifiers have been proven to be particularly advantageous for object detection. If a Support Vector Machine is used as a classifier, then it can take the form of a linear Support Vector Machine, for example, and in particular as a soft classifying Support Vector Machine. These classifiers enable a high speed of evaluation of the images, and require a relatively low level of computing capacity.

Here, as with the descriptors, different types of classifiers can be advantageous with regard to the detection of objects of different sizes.

For this reason, one embodiment of the method and the system provides that for different detectors, different types of classifiers are used.

In particular due to the use of several detectors and due to an evaluation of an image in which image sections which are covered by the detector windows of the detectors used are observed at a plurality of positions in the detector window, and due to an evaluation of the image in several scaling operations, an object contained in the image is generally detected several times over.

For this reason, a further embodiment of the method and the system provides that an individual object of the specified object category is detected several times within the image, wherein the multiple detection events for the object are compiled into a single detection event.

A related embodiment of the method and the system is characterised by the fact that a frequency distribution of detection events which occur during the evaluation of the image is evaluated, wherein at least one local maximum of the frequency distribution is determined, which is assigned to an object.

Due to a statistical evaluation of the detection events of this type, a particularly reliably compilation of the individual detection events for an object can advantageously be conducted.

Furthermore, a related further embodiment of the method and the system provides that the local maximum of the frequency distribution is determined by a Mean Shift method.

Advantageously, a Mean Shift method makes it possible to find the local maximum reliably and simply. In particular, the standards for the Mean Shift method are not generally too high with regard to the computing capacity required.

One embodiment of the method and the system is characterised by the fact that a detection event which occurs during the evaluation of the image is taken into account within the frequency distribution in accordance with the positions of the detector window in which the object has been detected, and in accordance with the scaling of the image in which the object has been detected.

The position of the detected object within the image advantageously results here from the position of the detector window in which the object has been detected within the detector window. Furthermore, the size of the detected object results from the scaling of the image in which the object has been detected, taking into account the size of the image and of the detector window.

The aforementioned connection between the scaling operation and the object size here applies to a fixed window size. If several detectors with detector windows of different sizes are used, the connection does not apply overall, but only specifically to one detector.

With one embodiment of the method and the system, it is thus provided that for each detector, a frequency distribution of the detection events is evaluated, wherein the local maximum corresponds to the frequency distribution which is evaluated for one detector of an object hypothesis of this detector, and wherein according to a concordance criterion, concordant object hypotheses of several detectors are compiled to a detection result for one object.

A related embodiment of the method and the system provides that from a scaling operation which is determined for the local maximum of the frequency distribution which is evaluated for a detector, from the size of the detector window of this detector and from the size of the image, the size of the object is determined, which corresponds to the object hypothesis of this detector.

Alternatively, one embodiment of the method and the system provides that the scaling of the image in relation to the size of the detector window results from a selected detector, according to which a detection event is taken into account in the frequency distribution, is adapted by a factor which results from the relative size of the detector window in which the object has been detected, wherein from a scaling operation which is determined for the local maximum of the frequency distribution, from the size of the detector window of the selected detector and from the size of the image, the size of the object is determined, which is assigned to the local maximum.

With this embodiment, the differences in the sizes of the detector windows are advantageously compensated by a factor which results from the relative size of the detector window in which the object has been recognised in relation to the size of the detector window of a selected detector. The latter can be any detector which is used, but one which has been firmly selected.

A further embodiment of the method and the system is characterized by the fact that the specified object category comprises motor vehicles, in particular cars, which are displayed in the front view.

Furthermore, one embodiment of the method and the system is characterized by the fact that the image is recorded using a camera which is arranged on a motor vehicle, and which points in the forwards direction of the motor vehicle.

Furthermore, a computer program product is provided which comprises a computer program which comprises commands for implementing a method of the type described above.

The aforementioned advantages, as well as other advantages, particular features and advantageous embodiments of the invention will also be explained on the basis of the exemplary embodiments which are described below with references to the figures.

### BRIEF DESCRIPTION OF THE DRAWINGS

In the figures:

FIG. 1 shows a schematic block view of a system for detecting objects in images which are recorded using a camera sensor,

FIG. 2a shows a schematic view of a context area in the area surrounding an object in a first arrangement, and

FIG. 2b shows a schematic view of a context area in the area surrounding an object in a further arrangement.

### DETAILED DESCRIPTION OF THE PREFERRED EMBODIMENTS

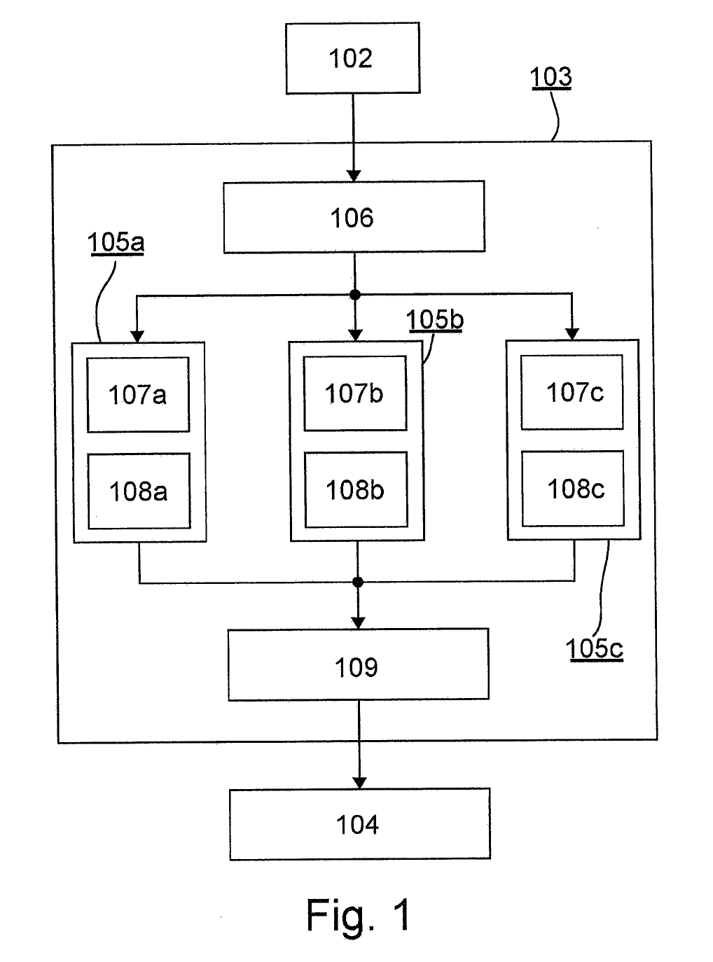

FIG. 1 shows a system 101 for detecting objects of a specified object category. The system contains a camera sensor 102 which comprises a CCD chip (CCD: Charged Coupled Device) for recording digital images with a specified resolution. The images are fed to an image processing device 103 which is designed for detecting objects of the specified object category within the images. The issue of the image processing device 103 comprises the positions and preferably the edges of the objects detected within the images of the specified object category, and can be transferred for the further processing of a further device 104. A basic category can in particular be specified as an object category, the members of which preferably comprise features which essentially concord, which are suitable for differentiating them from members of other basic categories. Examples of basic categories of this type are e.g. cars in a certain view, such as the front, rear or side view, human faces, persons standing upright, or similar.

In an exemplary embodiment, the system 101 can be arranged in a motor vehicle in order to record objects in the area surrounding the motor vehicle and to determine their positions. In particular, it can here be provided that the camera sensor 102 has a recording range which points in the forwards direction of the motor vehicle, and that the specified object category is several motor vehicles which appear in the front and/or rear view in the images recorded by the camera sensor. In this embodiment, the relative position of the motor vehicles can on the basis of the position and contours of the motor vehicles be determined in relation to the own motor vehicle. This data can for example be incorporated into a safety system of the motor vehicle in order to determine the risk of collision with other traffic and if appropriate, to trigger safety means in the motor vehicle. The safety system thus corresponds in this embodiment to the aforementioned device 104 for further processing the position data of the detected objects.

In the image processing device 103, an image recorded by the camera sensor is read in and evaluated following preparation in the block 106 with the aid of several detectors 105a, 105b, 105c of which three detectors are shown as an example in FIG. 1. The detectors 105a, 105b, 105c are each based on a descriptor and on a classifier applied to the descriptor, wherein in the schematic block view shown in FIG. 1, the calculation of the descriptors is conducted in blocks 107a, 107b and 107c. The classifiers are shown schematically by means of the blocks 108a, 108b and 108c.

A descriptor is a set of features of an image section which is preferably calculated in the form of a vector, which is also referred to as a descriptor vector or feature vector. The classifiers 108a, 108b, 108c determine on the basis of the descriptor whether an object of the specified category—referred to below as “object”—is contained in the image section. Here, a confidence or probability for the presence of the object can be determined by the classifier 108a, 108b, 108c, or a decision can be made as to whether an object is contained in the image section or not. In the latter case, the classifier 108a, 108b, 108c is binary.

By means of the detectors 105a, 105b, 105c, individual objects are generally detected several times within an image. For this reason, the detection events for an object are preferably compiled in order to determine the detection result. This procedure is also referred to below as a fusion of the detection results, and is conducted in the evaluation unit direction 109 of the system 101 to which the detection results of the detectors 105a, 105b, 105c are fed.

Each detector 105a, 105b, 105c is set up for the purpose of detecting objects of the specified category which have a size in a specified range within an image to be evaluated. The size ranges of the different detectors 105a, 105b, 105c are here selected in such a manner that when the detectors 105a, 105b, 105c are combined, the entire size range is covered in which the objects occur within the image material to be evaluated. Furthermore, the size ranges overlap. The variance of the object sizes in an image recorded by the camera sensor 102 is created due to different distances between the real objects and the camera sensor 102. Thus, for example, it was determined that motor vehicle front sides of oncoming motor vehicles comprise in the images of a typical on-board camera sensor of a motor vehicle with a resolution of 752×480 pixels, widths of between 10 and 200 pixels, depending on the distance from the camera sensor 102. Due to the use of several detectors 105a, 105b, 105c, a high detection capacity is guaranteed for the entire size range of the objects.

The individual detectors 105a, 105b, 105c respectively conduct an evaluation of the image data in a detector window which covers a section of the image. The size of the detector windows is here selected in accordance with the size ranges in which the detectors 105a, 105b, 105c are designed to detect objects. Thus, the sizes of the detector windows of the individual detectors 105a, 105b, 105c generally differ from each other. In order to evaluate the entire image, evaluations are conducted by each detector 105a, 105b, 105c at several positions of the detector window and during several scaling operations of the image. During each scaling operation, the detector windows here “slide” over the image and at each position of the detector window, one descriptor vector is calculated respectively for the image section which is covered by the window. This can then be conducted for the specified positions successively; however, in order to accelerate the evaluation, the evaluation can also be conducted in parallel at several positions on the detector window.

In one embodiment, at least within one of the detectors 105a, 105b, 105c used, a descriptor is calculated on the basis of gradients (HOG) which are oriented on the basis of histograms, which is also referred to as the HOG descriptor. The calculation of the HOG descriptor is conducted in a similar manner, as is described in the publication “Finding People in Images and Videos” by Navneet Dalal mentioned above. First, in an initial stage, a gamma or colour standardisation of the image is preferably conducted, which has been shown to be advantageous. This standardisation can be conducted in one stage for the entire image, and thus be implemented by the pre-processing block 106. In one embodiment, a gamma compression for each colour channel is conducted by forming a square, wherein the images are preferably present in RGB format, in which one colour channel is provided respectively for the primary colours red, green and blue. With the compression provided, the roots of the intensity are calculated at each image pixel for each colour channel, and with the subsequent processing of the image, they are used instead of the actual intensity (“\sqrt{RGB}−compression”). As a result, weak gradients in weakly lit areas of the image are strengthened so that in particular, lighting differences within the image and between different images are compensated. Furthermore, it is achieved that the photon noise which leads to image interferences, is almost even after the root formation, and thus with the following gradient formation leads at the most to a slight falsification. The reason for this is that the photon noise is proportionate to the root of the intensity of an image pixel. If the root of the overall intensity (“actual” J intensity plus photon noise k\sqrt{j} is formed, the following applies: \sqrt{J+k\sqrt{J}}=\sqrt{J}+k/2+O(1/\sqrt{J}).

In the next stage, which can be conducted within the detectors 105a, 105b, 105c, gradients of the intensities are calculated for the image section which is to be evaluated respectively and which is covered by the detector window. On the basis of the gradient formation, in particular contours are determined within the image. With colour images and in particular, with images in RGB format, gradients are preferably determined for each image pixel, wherein the gradient with the largest value or the largest norm is used for further processing.

The gradients are calculated for each colour channel by folding using a derivative mask. Here, the unidimensional mask [−1,0,1] or [−1,0,1]^{T} can for example be used for calculating the gradient along the x and the y axis. As a result of this mask, the gradient in the x direction results for an image pixel i,j in relation to a colour channel from

Gₓ(i,j)=\tilde{I}(i+1,j)−\tilde{I}(i−1,j)
and in the y direction by

G_{y}(i,j)=\tilde{I}(i,j+1)−\tilde{I}(i,j−1)

wherein Ĩ(i, j) designates the intensity of a colour channel of the image pixel (i, j) of the compressed image. When the root compression described above is used, Ĩ(i, j)=\sqrt{I(i, j)} thus applies, wherein I(i, j) designates the intensity of a colour channel on the pixel (i, j). Due to the mask used, the gradient \vec{G}(i, j) is centred with reference to the image pixel (i, j). In order to also be able to calculate gradients for the pixels on the edge of the image section when this mask is used, an edge area of 2 pixels around the image section is preferably taken into account for the calculation of the gradients.

As an alternative to the mask described above, other masks can also be used. In particular, the gradient calculation can here be also conducted in different detectors 105a, 105b, 105c in different ways.

From the calculated components and Gₓ and G_{y}, the value G of the gradient and the direction θ are calculated, wherein for the value, the following applies:

G=\sqrt{Gₓ²+G_{y}²}

and for the direction or orientation, the following applies:

$$θ = arc tan ( \frac{{G}_{y}}{{G}_{x}} ) .$$

For the further calculation of the HOG descriptor, the image section to be evaluated is divided into regions using a grid, which are designated as “cells” and which each comprise a specified number and arrangement of image pixels. In one embodiment, here, rectangular, in particular, square cells are provided which for example comprises between 2×2 and 10×10 image pixels. In particular cells with 4×4 image pixels have been proven to be particularly advantageous with regard to the detection of motor vehicles in a front view. Smaller cells did not result in any significant improvement in the experiments conducted, while larger cells led to a reduction in quality of the results, however.

In a fourth stage of the calculation of the HOG descriptors, an orientation histogram of the gradients is determined for each cell of the image section to be evaluated, wherein the gradients are assigned with a weighting to the classes of the histogram of a cell in accordance with their direction which corresponds to the value of the gradient. Here, a linear interpolation is conducted. Furthermore, the gradients are assigned to the cells or histograms according to the image pixel onto which they are centred. Here, an interpolation is conducted with reference to the x and y direction. In other words, a gradient which is centred onto a certain cell in an image pixel also delivers a contribution to the histograms of the adjacent cells. An interpolation is thus conducted with reference to the x and y component of the image pixel in which the gradient is centred, and with reference to the orientation of the gradient, so that a trilinear interpretation results which is explained in greater detail below:

With h(i, j, θ) here, the value of the class of histogramme for the cell which is centered around the orientation θ is designated, in the centre of which the image pixel (i, j) lies. If the cell comprises an even number of pixels in the horizontal or vertical expansion, in one embodiment, the coordinates of the pixels are viewed to the left or below the centre as the centre of the cell. Thus, for example, a cell with 4×4 pixels has the centre (2,2) insofar as the left-hand lower pixel is assigned the coordinates (1,1). If now it applies for one tuple (i, j, θ) consisting of one image pixel (i, j) and the orientation θ of a gradient which is centred in the image pixel that (1) iᵢ≦i<i₂ (2) j₁≦j<j₂ and (3) θ₁≦θ<θ₂, then the gradient which is centered in the image pixel (i, j) enters the “surrounding” histogramme classes with the value G and the orientation θ with the following values:

$$h ( {i}_{1} , {j}_{1} , {θ}_{1} ) \text{:} G \cdot ( 1 - \frac{i - {i}_{1}}{{b}_{x}} ) \cdot ( 1 - \frac{j - {j}_{1}}{{b}_{y}} ) \cdot ( 1 - \frac{θ - {θ}_{1}}{{b}_{θ}} )$$

$$h ( {i}_{1} , {j}_{1} , {θ}_{2} ) \text{:} G \cdot ( 1 - \frac{i - {i}_{1}}{{b}_{x}} ) \cdot ( 1 - \frac{j - {j}_{1}}{{b}_{y}} ) \cdot ( \frac{θ - {θ}_{1}}{{b}_{θ}} )$$

$$h ( {i}_{1} , {j}_{2} , {θ}_{1} ) \text{:} G \cdot ( 1 - \frac{i - {i}_{1}}{{b}_{x}} ) \cdot ( \frac{j - {j}_{1}}{{b}_{y}} ) \cdot ( 1 - \frac{θ - {θ}_{1}}{{b}_{θ}} )$$

$$h ( {i}_{2} , {j}_{1} , {θ}_{1} ) \text{:} G \cdot ( \frac{i - {i}_{1}}{{b}_{x}} ) \cdot ( 1 - \frac{j - {j}_{1}}{{b}_{y}} ) \cdot ( 1 - \frac{θ - {θ}_{1}}{{b}_{θ}} )$$

$$h ( {i}_{1} , {j}_{2} , {θ}_{2} ) \text{:} G \cdot ( 1 - \frac{i - {i}_{1}}{{b}_{x}} ) \cdot ( \frac{j - {j}_{1}}{{b}_{y}} ) \cdot ( \frac{θ - {θ}_{1}}{{b}_{θ}} )$$

$$h ( {i}_{2} , {j}_{1} , {θ}_{2} ) \text{:} G \cdot ( \frac{i - {i}_{1}}{{b}_{x}} ) \cdot ( 1 - \frac{j - {j}_{1}}{{b}_{y}} ) \cdot ( \frac{θ - {θ}_{1}}{{b}_{θ}} )$$

$$h ( {i}_{2} , {j}_{2} , {θ}_{1} ) \text{:} G \cdot ( 1 - \frac{i - {i}_{1}}{{b}_{x}} ) \cdot ( \frac{j - {j}_{1}}{{b}_{y}} ) \cdot ( 1 - \frac{θ - {θ}_{1}}{{b}_{θ}} )$$

$$h ( {i}_{2} , {j}_{2} , {θ}_{2} ) \text{:} G \cdot ( \frac{i - {i}_{1}}{{b}_{x}} ) \cdot ( \frac{j - {j}_{1}}{{b}_{y}} ) \cdot ( \frac{θ - {θ}_{1}}{{b}_{θ}} )$$

Here, bₓ designates the number of pixels in the horizontal expansion of a cell, and b_{y} designates the number of pixels in the vertical expansion of a cell, so that a cell in the above notation comprises bₓ×b_{y} image pixels. Here b_{θ} designates the width of a class of the orientation histogram of a cell.

In one embodiment which has been shown to be advantageous in particular with regard to the detection of a motor vehicle in a front view, the histograms of the cells 18 comprise classes with a width of 20° in the angle range of between 0 and 360°. With the following example, it is assumed that a block is present with 2×2 cells which respectively comprise 4×4 pixels, wherein the lower left-hand image pixel of the block has the coordinates (1,1) and the upper right-hand image pixel of the block accordingly has the coordinates (8,8). If the gradient which is centred in the marked image pixel with the coordinates (3,3) has the value G, and if it comprises an angle of 85° with the horizontal plane, for these gradients, the following values are incorporated into the histogrammes of the cells, for example: in the histogram of the lower left-hand cell with the centre (2,2), a value of G· 9/16·¼ is incorporated into the class centred around 70°, and a value of G· 9/16·¾ is incorporated into the class centred around 90°; in the histogrammes of the upper left-hand and lower right-hand cell with the centres (2,6) or (6,2), a value of G· 9/16·¼ is incorporated into the histogramme class centered around 70°, and a value of G· 9/16·3¼ is incorporated into the histogramme class centred around 90° respectively, and in the histogram in the right-hand upper cell with the centre (6,6), a value of G· 1/16·¼ is incorporated into the class centred around 70° and a value of G· 1/16·¾ is incorporated into the class centered around 90°. The two aforementioned classes which are centred around 70° and 90° are here assigned to value ranges with 60°≦θ<80° and 80°≦θ<100°.

After the histograms for the cells of the image section have been determined, the cells are compiled into blocks which overlap each other for the purpose of calculating the HOG descriptor, so that each cell is assigned to several blocks. When cells are used with 4×4 pixels respectively, it has been proven to be advantageous in one embodiment in relation to the detection of motor vehicles in the front view to use blocks with 8×8 pixels or 2×2 cells, which have a distance of one cell in the horizontal and the vertical direction. In this embodiment, the cells which are not located at the edge of the image section are thus covered 4 times.

A standardisation of the histograms of the cells is then conducted within the blocks. For the standardisation within a block, the histograms of the individual cells of the block are compiled into a vector. This vector is then standardised using a specified norm, which is also referred to as block standardisation. In particular, the use of the L1 norm has been proven to be advantageous in relation to the detection of motor vehicles in the front view, wherein the root of the L1 standardisation is used as a standardised expression. This standardisation schema is also referred to below as \sqrt{L₁}−standardisation.

With the following explanation of the block standardisation, it is assumed that the vector ν₁=[ν_{i,1}, . . . , ν_{i,n}] is the vector representation of the histogramme of a specific cell i of a block with m cells which comprises n classes, wherein in the vector νᵢ each component represents the value of a class of the historgramme of the cell i. In order to implement the block standardisation, a descriptor vector ν=[ν₁, . . . , νₘ] is first determined for the block. When the \sqrt{L₁}−standardisation is used, the standardised descriptor vector of the block can be given by

$$\overline{v} = \sqrt{\frac{v}{{‖ v ‖}_{1} + {ɛ}^{′}}}$$

Wherein with ∥ν∥₁ the L1 norm of the vector ν is designated, which is given by

$${‖ v ‖}_{1} = {\sum }_{k = 1}^{m} {‖ {v}_{k} ‖}_{1} = {\sum }_{k = 1}^{m} {\sum }_{l = 1}^{n} \vert {v}_{k , l} \vert .$$

ε is the standardisation constant the insertion of which prevents a division by zero. Furthermore, this also serves the purpose of regularisation. In other words, due to a correspondingly large selection of ε a too large strengthening of weak gradients in the homogeneous environment is avoided. As an alternative to the \sqrt{L₁}−standardisation, the block standardisation can for example be conducted also using a pure L1 standardisation with ν̅=ν/∥ν∥₁+ε or using the L2 norm with ν̅=ν/\sqrt{∥ν∥₂²+ε²}, wherein the following applies:

∥ν∥₂=Σₖ₌₁^{m}∥νₖ∥₂=Σₖ₌₁^{m} Σₗ₌₁ⁿν_{k,l}².

The resulting descriptor vector or feature vector for the image section to be evaluated results subsequently from a combination of the standardised descriptor vectors of the individual blocks of the image section. If the image section p comprises blocks for which a standardised descriptor vector ν̅ᵢ has been determined respectively, then the resulting descriptor vector is thus given for the image section in relation to a colour channel by:

f=└ ν̅₁, . . . , ν̅ₚ┘

Due to the block standardisation using overlapping blocks, the values of the histogram of a cell are contained several times in the final descriptor vector, as a result of which the detection capacity—as has been shown—is improved.

As an alternative to the HOG descriptors described above, within the scope of the invention, other descriptors can also be used in one or more detectors 105a, 105b, 105c. Examples of these are SIFT descriptors which are described in D. G. Lowe, “Object Recognition from local scale-invariant features”, Proceedings of the 7th International Conference on Computer Vision, Kerkyra, Greece, 1999, pages 1150-1157, or on Haar-Wavelets based descriptors which are described e.g. in C. P. Papageorgiou et al., “A general framework for object detection”, Proceedings of the 6th International Conference on Computer Vision, Bombay, India, 1998, pages 555-562, and in C. P. Papageorgiou, T. Poggio, “A trainable system for object detection”, International Journal of Computer Vision, Volume 38 (1), June 2000, pages 15-33, which are all incorporated by reference. Further examples of descriptors which can be used within the scope of the invention are for example descriptors which are based on Shapelet features, as are described in P. Sabzmeydani and G. Mori, “Detecting Pedestrians by Learning Shapelet Features”, Computer Vision and Pattern Recognition, 2007, IEEE Conference, 17-22 Jun. 2007, pages 1-8, which is incorporated by reference.

The evaluation of the descriptor vector of an image section is conducted, as mentioned above, in the detectors 105a, 105b, 105c, respectively by a classifier 108a, 108b, 108c. The classifiers 108a, 108b, 108c are in an advantageous embodiment binary classifiers which due to an evaluation of the descriptor vector decide whether an object of the specified category is contained in the image section observed or not.

In one embodiment, some or all classifiers 108a, 108b, 108c are designed as a Support Vector Machine (SVM), in particular as linear SVM classifiers or as soft linear SVM classifiers.

A linear SVM classifier uses a hyper level which separates positive and negative points of a quantity of points which can be linearly separated into two classes. The hyper level comprises the points yε [symbol] ⁿ, which w·y+b=0 (wε [symbol] ⁿ, bε [symbol] ) applies, and the distance of a point xᵢ from the hyper level is given by

$${d}_{i} = \frac{w \cdot {x}_{i} + b}{‖ w ‖}$$

The hyper level is determined on the basis of training points in a manner known generally to persons skilled in the art using an optimisation algorithm. Here, the hyper levels are determined in such a manner that the training points which are closest to the hyper level have a maximum distance from the hyper level. These points are also referred to as support points or support vectors. Since the hyper level separates the two classes of points, the algebraic sign sgn(dᵢ) of the distance of a point from the level indicates the class to which the point belongs. If the hyper level is known, a new point can thus be classified by calculating its distance from the hyper level.

If a quantity can be separated into two classes, the following applies for a wε [symbol] ⁿ and a bε

[symbol]

λᵢ(w·xᵢ+b)≧1, i=1, . . . , N

for all N points of the quantity, wherein yε{−1,1} gives the class of the point xᵢ. Together with the previous equation, it results that λᵢdᵢ≧1/∥w∥ applies and that 1/∥w∥ is thus the smallest possible distance of a point from a hyper level. Due to the optimisation method, a hyper level can thus be determined in which ∥w∥ or ½w·w is the maxima, under the condition that for all points of the quantity, λᵢ(w·xᵢ+b)≧1 applies.

In a further embodiment, one or more classifiers 108a, 108b, 108c are designed as soft SVM classifiers. Here, false classifications of fewer points are tolerated, in order to increase efficiency. Here, the following applies for a wε [symbol] ⁿ and a bε

[symbol]

λᵢ(w·xᵢ+b)≧1−ξᵢ, i=1, . . . ,N

for all N points of the quantity, wherein yε{−1,1} gives the class of the point xᵢ, and ξᵢ is a non-negative parameter which is assigned to this point. The hyper level which is sought results in this case from the solution of the optimisation problem, that ½w·w+CΣᵢ₌₁^{N}ξᵢ is the maxima under the condition that λᵢ(w·xᵢ+b)≧1−ξᵢ applies. Here, C is a specified regularisation parameter which influences the behaviour of the soft SVM classifier. With high values of C, only a very small number of falsely classified points exists, while with a small C, a larger maximum distance between the next point and the separating hyper level results. The parameter C can for example adopt values of between 0.0001 and 0.1, preferably a value of 0.1.

In a further embodiment, as an alternative to the SVM classifier for one or more detectors 105a, 105b, 105c, a classifier 108a, 108b, 108c can be set up which is based on an AdaBoost method (AdaBoost stands for Adaptive Boosting). AdaBoost methods are known for example in J. Friedman et al., “Additive Logistic Regression: A statistical View of Boosting”, The Annals of Statistics, 2000, Vol. 28, No. 2, pages 337-407, which is incorporated by reference. They provide that on the basis of training data, a “strong” classifier is generated from a plurality of “weak” classifiers. The weak classifiers are here incorporated into the strong classifier with different weightings, wherein the weightings in a training method are determined on the basis of the training data. The weak classifiers here provide for example the comparison of individual image features, i.e. of individual components of the feature vector or a group of components of the feature vector with specified threshold values.

The training data used for training the detectors 105a, 105b, 105c or the classifiers 108a, 108b, 108c comprise positive training images which contain an object to be detected and negative training images which do not contain an object to be detected. Within the scope of the training method, the classifiers 108a, 108b, 108c are designed for the purpose of differentiating between these two classes of training images.

The positive training images have the size of the detector window of the detector 105a, 105b, 105c to be trained and are in one embodiment essentially completely filled by an object of the specified object category. Here, the positive training images can for example be generated when objects are cut out of existing images by eye. For this purpose, a frame can be manually created using an image processing program which just encloses the objects, and the content of the frame is cut out. Here, the images used can already be recorded in such a manner that the objects have the size which corresponds to the detector window. Generally, however, this is not the case, so that the image sections are scaled to the size of the detector window in order to generate the positive training images. Within the scope of the training method for a detector 105a, 105b, 105c with a detector window of 20×20 pixels, a positive training image with an original size of 40×40 pixels is here for example scaled to a size of 20×20 pixels.

The negative training images also have the size of the detector windows, but are randomly cut out of existing image material and contain no objects of the specified object category.

In a further embodiment, one or more detectors 105a, 105b, 105c are trained to even evaluate information regarding the context in which the object is located within an image, as well as regarding the object itself. It was determined that as a result, the detection capacity with small objects can be improved. This can be explained by the fact that in particular smaller objects comprise fewer details within the image material which can be used to detect the object, which can be compensated by taking into account context information. Here, it is assumed that a detector 105a, 105b, 105c or a classifier 108a, 108b, 108c is capable of learning that the objects to be detected generally occur within defined contexts. Thus, within an image, a roadway subground is generally present beneath a motor vehicle, which can for example be differentiated from a forest or sky which is not generally located beneath a motor vehicle.

The context information is taken into account on the basis of cells which are arranged within the training images and the image sections to be evaluated around the object. The number of cells can here for example be selected in such a manner that the context comprises up to 80% of a detector window, and the object itself just 20%. Furthermore, different arrangement of these cells are also possible. Thus, the additional cells can for example completely surround an object, or they can only partially surround the object. Insofar as the latter is the case, it has been proven to be advantageous, in particular when detecting motor vehicles, that at least one context area beneath the motor vehicle is taken into account. Here, such an area is, as mentioned above, the subground on which the real motor vehicles are located, which can be differentiated from a context which is generally not found beneath a motor vehicle.

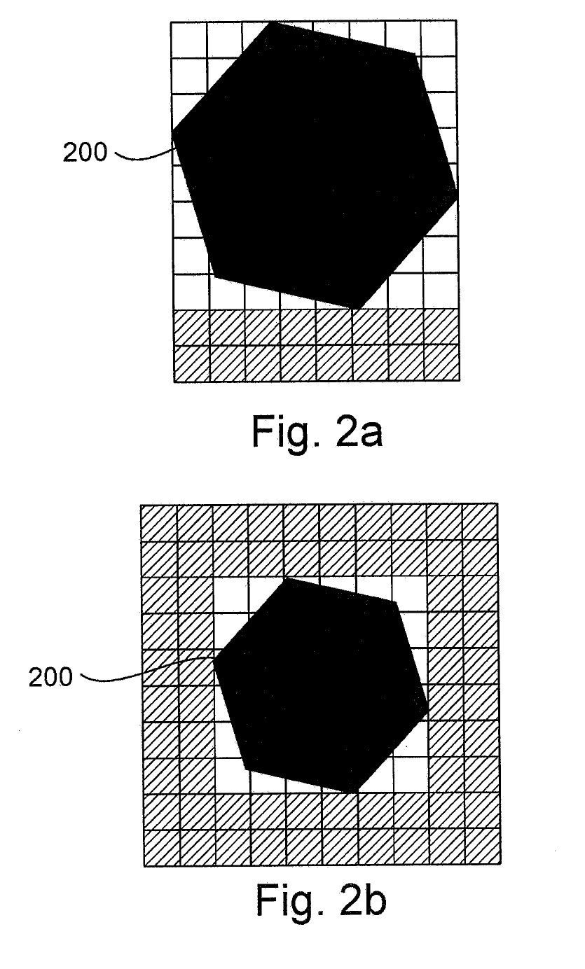

In FIGS. 2a and 2b, respectively for one image section or one detector window with 8×10 or 10×10 image pixels, exemplary arrangements of cells which contain context information of the image section are shown schematically in relation to a hexagonal object 200. Each cell is here shown in the figures as a box, and shaded boxes correspond to cells which contain context information. With the arrangement shown in FIG. 2, the context area is arranged only below the hexagonal object 200. With the arrangement shown in FIG. 2b, the hexagonal object is completely surrounded by the context area. In both cases, the context area has a width of 2 cells.

Insofar as context information should be taken into account from a detector 105a, 105b, 105c, the positive training images are selected in such a manner that they comprise, alongside the objects, cells with context information in a specified number and arrangement. For this purpose, training images can be cut out of existing image material in the size of the detector window of the detector 105a, 105b, 105c to be trained, in such a manner that alongside the objects, an edge area remains in the specified arrangement and with the specified width.

Within the scope of the training method, the descriptors used for the positive and negative training images are calculated from the detector 105a, 105b, 105c to be trained. Then, the training off the classifier 108a, 108b, 108c used by the detector 105a, 105b, 105c is conducted on the basis of the descriptor vectors, which represent the training points of the classifiers 108a, 108b, 108c. When an SVM classifier is used, the hyper level described above is calculated from the positive and negative training points on the basis of an optimisation method. When an AdaBoost classifier is used, the weightings of the weak classifiers are determined on the basis of the positive and negative training points.

Furthermore, the training of the detectors 105a, 105b, 105c or the classifiers 108a, 108b, 108c is preferably conducted in two stages. In the first stage, the detector 105a, 105b, 105c is trained with an arbitrary set of positive and negative training examples. Then, further negative training examples are fed to the detector 105a, 105b, 105c trained in the first stage. Here, the so-called hard examples are extracted, i.e. the negative training examples in which the detector 105a, 105b, 105c detects one of the specified objects. In a second stage, the detector 105a, 105b, 105c is then trained using the training data and the hard examples used in the first stage. As a result, the final detector 105a, 105b, 105c is created which can be used to detect objects of the specified class.

As has already been mentioned above, image sections in the size of the respective detector window are evaluated in order to detect objects within an image recorded by the camera sensor 102 of each detector 105a, 105b, 105c in the size of the respective detector window. This occurs at a plurality of positions which cover the entire image. Adjacent positions have a specified distance in the horizontal and vertical direction which is also referred to below as the step size. The step size has a value, for example, of between 1 pixel and 10 pixels, preferably 2 pixels. At each position, a descriptor vector is calculated in the manner described above for the image section covered by the detector window and is assigned to the classifier 108a, 108b, 108c of the corresponding detector 105a, 105b, 105c in order to ascertain whether an object of the specified object class is contained in the covered image section. Furthermore, the evaluation is conducted with several scaling operations of the image. On the basis of a size of the original image of nₓ×n_{y} pixels, a scaled image has (s·nₓ)×(s·n_{y}) pixels. Preferably, the image is here reduced in stages (i.e. the scaling operations used are less than 1). The smallest scaling with the evaluation by a certain detector 105a, 105b, 105c is the one in which the detector window still completely covers the image. In each scaling operation provided, the image is evaluated to the specified positions of the detector window which are at a defined distance. The number of possible positions is here reduced as the image becomes increasingly smaller until with the smallest scaling operation, only a row or a column of positions are to be evaluated.

The scaling operations differ by a specified factor S. Here, the following scaling operation sᵢ₊₁ results, respectively due to a division of the scaling operation by S (i.e. sᵢ₊₁=sᵢ/S), so that sₙ=1/Sⁿ applies. The operation is begun in the original size of the image, i.e. sₒ=1. The scaling factor S lies for example between 1 and 1.3, preferably at 1.05. On the basis of an image of 752×480 pixels, scaled images are thus evaluated within the scope of the evaluations with (752×480 pixels)/1.05=716×457 pixels, (752×480 pixels)/1.05²=682×435 pixels, (752×480 pixels)/1.05³=649×415 pixels etc. For the evaluation by a 40×40 detector, the smallest scaled image which is still completely covered by the detector window is for example the image with (752×480 pixels)/(1.05)⁵¹=60×40 pixels.

In one embodiment, the detector windows slide over the image and at each specified position, the descriptor is calculated respectively and is evaluated by the classifier 108a, 108b, 108c. In order to increase the speed, a parallel calculation of the descriptors is however conducted at a plurality of positions of the detector window.

Due to the plurality of positions of the detector window and the scaling operations of the image which are taken into account when the image is evaluated, a single object is generally detected several times. Here, an object can be detected by a detector 105a, 105b, 105c at several positions on the detector window and/or in several scaling operations of the image. Furthermore, an object can be detected by several detectors 105a, 105b, 105c. It is therefore necessary to reduce the plurality of detection events which have occurred during the evaluation in relation to a single object to a single detection of the object at a certain position within the image and with a specific size in order to achieve a “final result” for the detection of the object. This procedure, known as fusion, is conducted in the evaluation unit 109.

In one embodiment, the fusion is based on the study of a frequency with which detection events occur at a certain position of the image and in a certain scaling of the image. The local maxima of the frequency distribution correspond to the objects within the image. This distribution corresponds to a probability density which can be approximated by a core density estimator. The local maxima, i.e. the modes of the probability density function, are advantageously determined in one embodiment on the basis of a Mean Shift method, as is described in the aforementioned publication by N. Dalai and in a similar manner also in D. Commaniciu, P. Meer: “Mean Shift: A Robust Approach Toward Feature Space Analysis”, IEEE Transactions on Pattern Analysis and Machine Intelligence, Vol. 24, no. 5, May 2002, which is incorporated by reference.

In one embodiment, the evaluation is initially conducted for each detector 105a, 105b, 105c separately. Here, the N detection events which have been determined by a detector 105a, 105b, 105c are interpreted as points yᵢ=(xᵢ, yᵢ, sᵢ) in a three-dimensional space. The dimensions comprise the position (xᵢ, yᵢ) of the object and the scaling sᵢ of the evaluated image in which the object has been detected. The position (xᵢ, yᵢ) of the object here corresponds for example to the middle pixel of the detector window in which the object has been detected. On the basis of the scaling, the size of the object within the image can be determined, taking into account the size of the detector window and the expansion of the context information taken into account by the detector 105a, 105b, 105c and the size of the image. In order to determine the size of the object within the image, the size of the detector window must here be multiplied by the scaling, which is present at the maximum. If for example the image has 200×200 pixels and a detector 105a, 105b, 105c has a window of 50×50 pixels, and if a scaling factor of 2 has been determined for the maximum, the maximum corresponds to a detection event with the evaluation of the image scaled to 100×100 pixels. Within the original image, the object thus has a size of 100×100 pixels.

The aforementioned probability density at a point y of this space can be approximated by

$${f}^{̑} ( y ) = \frac{1}{{N ( 2 π )}^{3 / 2}} {\sum }_{i = 1}^{N} {\vert {H}_{i} \vert}^{- 1 / 2} t ( {d}_{i} ) exp ( - \frac{1}{2} {D}^{2} [ y , {y}_{i} , {H}_{i} ] )$$

wherein D²[y, yᵢ, Hᵢ]=(y−yᵢ)^{T}Hᵢ⁻¹(y−yᵢ) of the Mahalanobis distance between y and yᵢ and H is the so-called covariance or margin matrix. However, instead of the Mahalanobis distance, a distance can equally be used which is calculated on the basis of another norm, such as the Euclidic norm.

The expression t(dᵢ) corresponds to a weighting of the detection event i and takes into account the reliability with which the object has been detected. When an SVM classifier is used, the weighting can for example be determined in dependence on the distance dᵢ of the descriptor vector from the hyper level. In one embodiment, the weighting can only then be unequal to zero when the distance dᵢ of the descriptor vector from the hyper level is greater than a threshold value c. If this is the case, a weighting factor t(dᵢ)=dᵢ−c can be used, for example.

The covariance matrices Hᵢ give the unreliability of the points yᵢ. In one embodiment, the covariance matrices are diagonal, and are given by

Hᵢ=diag((exp(sᵢ)σₓ)²,(exp(sᵢ)σ_{y})²,(σₛ)²)

The values σₓ, σ_{y} and σₛ are specified smoothing parameters. Due to the exponential functions, the unreliability in the position of the detection events increased by an increasing factor sᵢ, i.e. with a reduced resolution of the images. This corresponds to the intuition according to which the precision reduces in this case when the positions of the objects are determined.

In order to simplify the following expression, the abbreviation

$${ϖ}_{i} ( y ) = \frac{{\vert {H}_{i} \vert}^{- 1 / 2} t ( {d}_{i} ) exp ( - {D}^{2} [ y , {y}_{i} , {H}_{i} ] / 2 )}{{\sum }_{i - 1}^{N} {\vert {H}_{i} \vert}^{- 1 / 2} t ( {d}_{i} ) exp ( - {D}^{2} [ y , {y}_{i} , {H}_{i} ] / 2 )}$$

is introduced. When this abbreviation is used, the so-called Mean Shift vector is given at the point y by

$$m ( y ) := {H}_{h} \frac{∇ {f}^{̑} ( y )}{{f}^{̑} ( y )} = {H}_{h} ( y ) [ {\sum }_{i = 1}^{N} {ϖ}_{i} ( y ) {H}_{i}^{- 1} {y}_{i} ] - y$$

with Hₕ⁻¹(y)=Σᵢ₌₁^{N} ω̅ᵢ(y)Hᵢ⁻¹ The Mean Shift vectors are proportionate to the gradients ∇\hat{ƒ} of the probability density and thus define a path to a local maximum of the probability density. Due to the multiplication of the gradient with 1/\hat{ƒ}·Hₕ, the gradient is here standardised in such a manner that the path converges in the local maximum.

In particular, the points Yₖ₊₁=Yₖ+m(Yₖ) are recursively calculated in order to determine a local maximum, based on a starting point Y₀. Here, it can be seen that the sequence of these points converges against a local maximum. Thus, the points are calculated until Yₖ₊₁ is equal to or essentially equal to Yₖ. If this is the case, Yₖ₊₁ or Yₖ corresponds to a sought for local maximum of the probability density. In order to determine all local maxima of the probability density, the method is conducted on the basis of all detection events yᵢ which have been determined by a detector 105a, 105b, 105c.

As has been mentioned above, the previous evaluation is conducted separately for each detector 105a, 105b, 105c used, in order to determine the positions and sizes of the detected objects for each detector 105a, 105b, 105c. The results of the evaluation which have been determined for the different detectors 105a, 105b, 105c are now compiled. Here, overlapping object hypotheses which have been detected by the different detectors 105a, 105b, 105c can be evaluated according to a specified concordance criterion as one single object. In particular, the matching criterion can provide that the object hypotheses must mutually overlap by at least 50%, i.e. that the first object must overlap the second object by 50%, and that the second object must overlap the first object by 50%, and that the distance between the object hypotheses totals a maximum of 50% of the width of the object.

In a further embodiment, the detection events of all detectors 105a, 105b, 105c used are jointly taken into account within the evaluated probability density. For this purpose, however, the scaling operations of the image are adapted to the detectors 105a, 105b, 105c in which the detection events have respectively been determined. I particular, a “standardisation” is here conducted to the size of a detector window. If for example a first detector 105a, 105b, 105c with a detector window of 20×20 pixels and a second detector 105a, 105b, 105c with a detector window of 40×40 pixels are used, and if a standardisation to the size of the detector window of the first detector 105a, 105b, 105c is conducted, the detection events which have been determined in the second detector 105a, 105b, 105c are incorporated into the probability density with an enlarged scaling factor sᵢ by factor 2. As a result, a conclusion can be directly made regarding the size of the object from the scaling factor which is determined for the local maximum of the probability density, and taking into account the size of the image.

As has been mentioned above, the detection system 101 is particularly suitable for use in a motor vehicle in order to detect oncoming motor vehicles and to determine their position and size. On the basis of a specified real size of the oncoming motor vehicles, and taking into account the display properties of the camera sensor 102, the distance to the oncoming motor vehicles can then be determined from the size. From a comparison of the distances which have been determined at different points in time, the relative speed of an oncoming motor vehicle can be determined in relation to the camera sensor 102 or to the own motor vehicle.

In an embodiment already named above, the camera sensor here delivers images with a size of 752×480 pixels in which the front views of oncoming motor vehicles comprise a width of between 10 and 200 pixels. In order to detect the front views of motor vehicles in the images of the camera sensor 102, an image processing system with three detectors 105a, 105b, 105c has been proven to be advantageous, which comprise detector windows with 20×20 pixels, 32×32 pixels and 40×40 pixels. In relation to the 40×40 detector, it has furthermore been proven to be advantageous when said detector takes into account context information which is contained in an edge area with a width of one cell, which completely surrounds the object. For the 20×20 detector and the 32×32 detector, it has been proven to be advantageous for the detection capacity when said detectors take into account context information which is contained in an edge area with a width of one cell which surrounds the object.

However, the invention is not restricted solely to the embodiments of the object detection system 101 described above. In particular, persons skilled in the art will recognise that the invention is not restricted to the detection of oncoming motor vehicles, but in a similar manner, can be used to detect objects of any object category. The design of the detection system 101, i.e. in particular, the number of detectors used and their design, is here preferably adapted to the specified useful purpose. Thus, for example, the number of detectors 105a, 105b, 105c used results in particular from the range in which the sizes of the objects to be detected vary within the images to be evaluated.

1.-25. (canceled)

26. A method for detecting an object of a specified object category in an image, comprising the steps of:
detecting an object of the specified object category with a specified object size by at least two window-based detectors, wherein window sizes of the window-based detectors differ,
evaluating the image, by the detectors, in order to check whether an object of the specified object category is located at a certain point in the image,
detecting an object of the specified object category at a certain point in the image when it is determined that an object of the specified object category is located in the image on the basis of the evaluation of the image by at least one of the detectors.

27. A method according to claim 26, wherein each detector evaluates at least one section of the image which is covered by the detector window, wherein the size of a detector window of the detectors is adapted to an object size provided for the detector.

28. A method according to claim 27, wherein each detector conducts evaluations of image sections which are covered by the detector window of the detector at a plurality of positions of the detector window in the image, wherein the positions are at a specified distance from each other.

29. A method according to claim 27, wherein the image is evaluated in a plurality of scaling operations, wherein during each scaling operation of the image, each detector conducts evaluations of image sections which are covered by the detector window of the detector at a plurality of positions of the detector window in the image.

30. A method according to claim 27, wherein at least one first detector is set up for a purpose of accounting for image information when evaluating an image section, which is covered by the detector window of the first detector, and, which is located in the image section in a first surrounding area of an object of the specified object category.

31. A method according to claim 30, wherein the first surrounding area comprises a part of the image section which is located below the object and/or that the surrounding area completely surrounds the object.

32. A method according to claim 30, wherein at least one additional detector is set up for the purpose of taking into account image information when evaluating an image section which is covered by the detector window of the additional detector which is located in a second surrounding area of an object of the specified object category, wherein the additional detector is designed to detect smaller objects than the first detector, and wherein a share of the second surrounding area on the image section which is covered by the detector window of the additional detector is larger than a share of the first surrounding area on the image section which is covered by the detector window of the first detector.

33. A method according to claim 27, wherein the evaluation of an image section which is covered by a detector window of a detector comprises the calculation of a descriptor, wherein the descriptor is fed to a classifier which determines whether an object of the specified object category is located in the image section.

34. A method according to claim 33, wherein the calculation of the descriptor comprises a gamma compression of the image.

35. A method according to claim 33, wherein the calculation of the descriptor comprises a calculation of intensity gradients within the image and a creation of a histogram for the intensity gradients in accordance with an orientation of the intensity gradients.

36. A method according to claim 35, wherein the image section is subdivided into several cells, which each comprise several pixels of the image section, wherein for each cell, a histogram is created into which the intensity gradients which are calculated in relation to the pixels of the cell are accommodated, and that several cells are respectively compiled into a block, wherein one cell is assigned to several blocks, and that the histograms are compiled and standardized in blocks, wherein the descriptor results from a combination of the descriptors which are compiled and standardized in blocks.

37. A method according to claim 33, wherein for the different detectors, different types of descriptors are used.

38. A method according to claim 33, wherein the classifier is a Support Vector Machine or the classifier is based on an AdaBoost method.

39. A method according to claim 33, wherein for different detectors, different types of classifiers are used.

40. A method according to claim 26, wherein a single object of the specified object category is detected several times within the image, wherein multiple detection events for the object are compiled into a single detection event.

41. A method according to claim 26, wherein a frequency distribution of detection events which occur during the evaluation of the image is evaluated, wherein at least one local maximum of the frequency distribution is determined, which is assigned to an object.

42. A method according to claim 41, wherein the local maximum of the frequency distribution is determined using a Mean Shift method.

43. A method according to claim 41, wherein a detection event which occurs during the evaluation of the image is taken into account within the frequency distribution in accordance with the positions of the detector window in which the object has been detected, and in accordance with scaling of the image in which the object has been detected.

44. A method according to claim 41, wherein for each detector, a frequency distribution of the detection events is evaluated, wherein the local maximum corresponds to the frequency distribution which is evaluated for one detector of an object hypothesis of this detector, and wherein according to a concordance criterion, concordant object hypotheses of several detectors are compiled to a detection result for one object.

45. A method according to claim 44, wherein from a scaling operation which is determined for the local maximum of the frequency distribution which is evaluated for a detector, from the size of the detector window of this detector and from the size of the image, the size of the object is determined, which corresponds to the object hypothesis of this detector.

46. A method according to claim 43, wherein scaling of the image in relation to the size of the detector window results from a selected detector according to which a detection event is taken into account in the frequency distribution, is adapted by a factor which results from a relative size of the detector window in which the object has been detected, wherein from a scaling operation which is determined for the local maximum of the frequency distribution, from the size of the detector window of the selected detector and from the size of the image, the size of the object is determined, which is assigned to the local maximum.

47. A method according to claim 26, wherein the specified object category comprises motor vehicles which are displayed in the front view.

48. A method according to claim 26, wherein the image is recorded by a camera sensor which is arranged on a motor vehicle and which points in a forward direction of the motor vehicle.

49. A computer program product comprising a computer program which comprises commands for implementing a method according to claim 26 on a processor.

50. A system for detecting an object of a specified object category in an image, comprising:
at least two detectors which are respectively configured for the purpose of detecting an object of the specified object category with a specified object size, wherein the object sizes differ for the detectors, and
an evaluation unit which is designed to determine the detection of an object of the specified object category within the image, when it is determined by at least one of the detectors that an object of the specified object category is located in the image.
